(19) United States
(12) Patent Application Publication
(10) Pub. No.: US 2025/0158466 A1
(43) Pub. Date: May 15, 2025

(54) ROTARY ELECTRIC MACHINE

(71) Applicant: MCF Electric Drive Corporation, Hiroshima (JP)

(72) Inventor: Naoki ITASAKA, Hiroshima (JP)

(21) Appl. No.: 18/941,850

(22) Filed: Nov. 8, 2024

(30) Foreign Application Priority Data
Nov. 13, 2023 (JP) 2023-193204

(51) Int. Cl. H02K 1/32; H02K 1/276

(52) U.S. Cl. CPC H02K 1/32; H02K 1/276

(57) ABSTRACT

A rotary electric machine includes a rotor, a shaft, a shaft passage, and a rotor passage. The rotor passage has an upstream passage and a downstream passage. The upstream passage includes a first upstream passage and a second upstream passage arranged in a circumferential direction of the rotor. A first radial position of an outer circumferential end of the first upstream passage is defined radially outwardly or radially inwardly of a second radial position of an outer circumferential end of the second upstream passage.

### CROSS-REFERENCE TO RELATED APPLICATIONS

The present application claims priority from Japanese Patent Application No. 2023-193204 filed with the Japanese Patent Office on Nov. 13, 2023, the entire contents of which are incorporated herein by reference.

### TECHNICAL FIELD

The present disclosure relates to a rotary electric machine that can be used for a drive source of an electric vehicle, for example.

### BACKGROUND OF THE DISCLOSURE

As a usual practice, there is a suggested technique for cooling permanent magnets included in a rotary electric machine. For example, Japanese Laid-Open Patent Publication No. 2014-176235 discloses that a cooling oil is supplied, through a coolant passage provided inside a shaft, to a coolant flow channel provided inside a rotor. The cooling oil flowing through the coolant flow channel thus cools the permanent magnets.

### SUMMARY

When a rotor has, for example, different media (for example, electromagnetic steel plates, permanent magnets, and gaps) present depending on circumferential locations, the differences in mechanical properties may occur depending on the circumferential locations. When a rotor includes a coolant flow channel as described in JP2014-176235, without taking into account those differences in mechanical properties depending on circumferential locations, portions having relatively lower mechanical properties may be produced in a certain circumferential location of the rotor. As the portions having relatively lower mechanical properties are subjected to local stress concentration due to centrifugal force during rotation of the rotor, the reliability of the rotor may be affected.

The present disclosure is made in view of the foregoing and an object of the present disclosure is to provide a rotary electric machine having improved reliability of a rotor as compared to the conventional ones, while cooling permanent magnets.

To achieve the object, the present disclosure is directed to a rotary electric machine including a rotor including a permanent magnet; a shaft configured to rotatably support the rotor; a shaft passage provided inside the shaft; and a rotor passage into which a liquid coolant flows from the shaft passage through a flow inlet that is an opening on an inner circumferential surface of the rotor, wherein the rotor passage includes an upstream passage extending radially outwardly from the flow inlet, and a downstream passage connecting to the upstream passage and extending in an axial direction, the upstream passage includes a first upstream passage and a second upstream passage arranged in a circumferential direction of the rotor, and a radial position of an outer circumferential end of the first upstream passage is defined radially outwardly or radially inwardly of a radial position of an outer circumferential end of the second upstream passage.

According to the present disclosure having such configurations, the liquid coolant flowing from the shaft passage into the rotor passage can cool the permanent magnets. Also, the radial position of the outer circumferential end of the first upstream passage is different from the radial position of the outer circumferential end of the second upstream passage, so that the differences in mechanical properties of the rotor that vary depending on circumferential locations can be smaller as compared to the conventional ones. Thereby, even when local stress concentration develops due to centrifugal force during rotation of the rotor, it is possible to reduce its influence on reliability of the rotor.

In the present disclosure, the first upstream passage preferably extends along a q-axis direction and the second upstream passage preferably extends along a d-axis direction.

According to the present disclosure having such configurations, the radial position of the outer circumferential end of the first upstream passage that extends along the q-axis direction is different from the radial position of the outer circumferential end of the second upstream passage that extends along the d-axis direction, so that the differences in the mechanical properties of the rotor between circumferential locations corresponding to the q-axis and d-axis directions can be smaller as compared to the conventional ones.

In the present disclosure, the first upstream passage and the second upstream passage are preferably provided alternately in the circumferential direction of the rotor.

According to the present disclosure having such configurations, the first upstream passage and the second upstream passage are provided alternately in the circumferential direction of the rotor. Thereby, the differences in the mechanical properties of the rotor that vary depending on the circumferential locations can be further smaller as compared to the conventional ones.

In the present disclosure, an outer circumferential portion of the upstream passage preferably has an elliptical shape in axial cross-section.

According to the present disclosure having such configurations, the outer circumferential portion of the upstream passage has an elliptical shape in axial cross-section. Thereby, the outer circumferential end portion of the upstream passage has a larger R as compared to the case of a round shape. This allows distributed stress acting on the outer circumferential end portion of the upstream passage during the rotation of the rotor, for example.

In the present disclosure, the flow inlet is preferably provided in an axially central portion of the rotor, the downstream passage includes a first downstream passage provided on one axial side of the upstream passage, and a second downstream passage provided on another axial side of the upstream passage, the radial position of the outer circumferential end of the first upstream passage is defined radially inwardly of the radial position of the outer circumferential end of the second upstream passage, and a connection passage provided radially outwardly of the first upstream passage extends in the axial direction and connects the first downstream passage and the second downstream passage.

According to the present disclosure having such configurations, the flow inlet is provided in the axially central portion of the rotor, so that the liquid coolant flowing from the shaft passage into the upstream passage can be used to preferentially cool axially central portions of the permanent magnets, where the temperature is most likely to be higher, over other portions of the permanent magnets. Thereby, the axially central portions of the permanent magnets can be prevented from having a higher temperature. Also, the radial position of the outer circumferential end of the first upstream passage that is provided radially inwardly of the connection passage is defined radially inwardly of the radial position of the outer circumferential end of the second upstream passage, so that the differences in the mechanical properties between the circumferential location including the first upstream passage and the connection passage and the circumferential location including the second upstream passage can be smaller.

The present disclosure is directed to the rotary electric machine preferably further including a stator provided radially outside the rotor, a coil end provided in an axial end portion of the stator, an end plate provided in an axial end portion of the rotor, and a flow outlet passage provided in the end plate and extending in a radial direction, wherein the flow outlet passage includes an inner circumferential portion connecting to the downstream passage, and an outer circumferential end including a flow outlet oriented toward the coil end.

According to the present disclosure having such configurations, the liquid coolant used for cooling the permanent magnets as passing through the downstream passage flows out from the flow outlet to be supplied to the coil end. Thereby, the liquid coolant after cooling the permanent magnets also can be used for cooling the coil end.

In the present disclosure, the rotor and the shaft are preferably fixed by means of shrink-fitting.

According to the present disclosure having such configurations, the rotor and the shaft are fixed using shrink-fitting, so that fixing of the rotor to the shaft can be ensured. The upstream passage extending radially outwardly from the flow inlet that is an opening on the inner circumferential surface of the rotor also can reduce shrink-fitting stress acting on the rotor. This can further improve the reliability of the rotor.

The present disclosure can provide a rotary electric machine having improved reliability of a rotor as compared to the conventional ones, while cooling permanent magnets.

### BRIEF DESCRIPTION OF THE DRAWINGS

FIG. 1 is a schematic cross-sectional view illustrating a rotary electric machine according to an embodiment of the present disclosure.

FIG. 2 is a view illustrating a part of a first electromagnetic steel plate.

FIG. 3 is a view illustrating a part of a second electromagnetic steel plate.

FIG. 4 is a schematic cross-sectional view taken along a plane IV-IV indicated in FIG. 1.

FIG. 5 is a schematic cross-sectional view taken along a plane V-V indicated in FIG. 1.

### DETAILED DESCRIPTION

Embodiments of the present disclosure are described in detail below with reference to the drawings. It is noted that the following description of preferred embodiments is merely an example in nature.

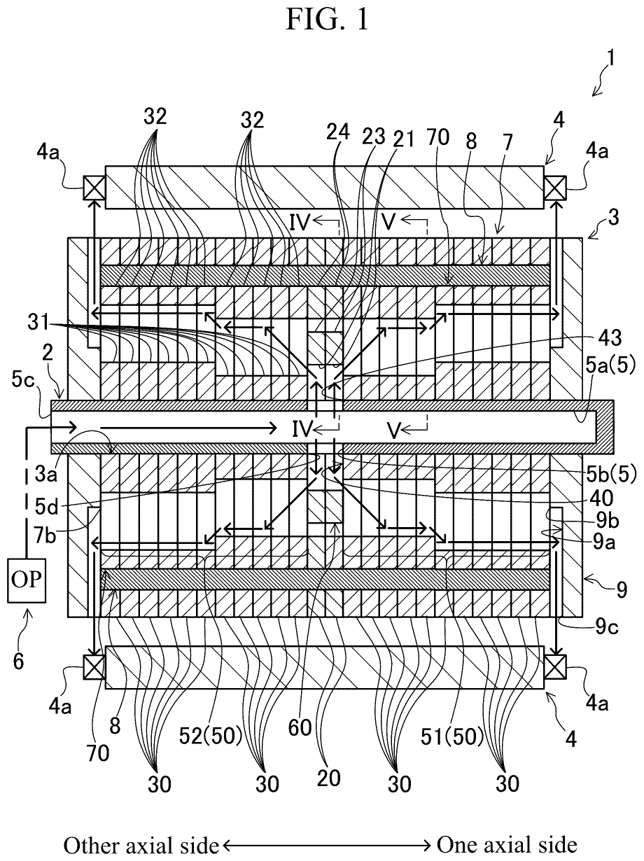

FIG. 1 shows a rotary electric machine 1 according to an embodiment of the present disclosure. The rotary electric machine 1 is an electric motor of an internal magnet type, which can be used for a drive source of an electric vehicle, for example.

The rotary electric machine 1 includes a shaft 2, a rotor 3 fixed on an outer circumferential surface of the shaft 2, and a stator 4 disposed radially outside the rotor 3 at a predetermined radial distance from the rotor 3. The shaft 2 is configured to rotatably support the rotor 3. A coil end 4a is provided in an axial end portion of the stator 4.

The shaft 2 forms an axis and is configured to be rotatably supported on a case (not shown) of the rotary electric machine 1 via a bearing (not shown). A shaft passage 5 is also provided inside the shaft 2.

The shaft passage 5 includes a first shaft passage 5a axially extending inside the shaft 2 and a plurality of second shaft passages 5b radially extending inside the shaft 2.

The first shaft passage 5a includes one axial end that is closed. The first shaft passage 5a also includes another axial end that is provided with a first flow inlet 5c. A cooling oil (liquid coolant) is then supplied from an oil pump 6 through the first flow inlet 5c to the first shaft passage 5a. In the embodiment, the oil pump 6 is configured to be driven by the shaft 2 or a power transmission shaft between the shaft 2 and wheels (not shown).

The rotary electric machine 1 generates torque, which is transmitted to the wheels (not shown) via a speed reducer (not shown). The cooling oil supplied from the oil pump 6 to the first shaft passage 5a can also be used as a lubricant oil for the speed reducer (not shown). In other words, the cooling oil of the rotary electric machine 1 and the lubricant oil of the speed reducer (not shown) are used in a shared fashion. In the embodiment, an automatic transmission fluid is used as the cooling oil.

The plurality of second shaft passages 5b are arranged at a predetermined distance from each other in a circumferential direction of the shaft 2. Each of the second shaft passages 5b includes an inner circumferential end that connects to an axially central portion of the first shaft passage 5a. Each of the second shaft passages 5b also includes an outer circumferential end that is provided with a first flow outlet 5d. In the embodiment, the first flow outlets 5d are provided on the outer circumferential surface of the shaft 2 at 22.5-degree intervals along the circumferential direction.

The rotor 3 which generally has a cylindrical shape includes a through hole 3a formed to penetrate in a central portion thereof, and is configured to be fixed to the shaft 2 in the state where the shaft 2 is inserted into the through hole 3a. In the embodiment, the shaft 2 and the rotor 3 are fixed by means of shrink-fitting. In shrink-fitting, for example, the rotor 3 is heated to expand the through hole 3a of the rotor 3, and the shaft 2 is then inserted into the through hole 3a, followed by cooling of the rotor 3 to contract the through hole 3a, so that the rotor 3 and the shaft 2 are fixed.

The rotor 3 also includes a rotor core 7, a plurality of permanent magnets 8 (for example, rare-earth magnets, such as neodymium), and a pair of end plates 9. The end plates 9 have generally a disk shape and are disposed on axial ends of the rotor core 7, respectively. In other words, the pair of end plates 9 are provided in respective axial end portions of the rotor 3 so as to sandwich the rotor core 7 in the axial direction.

The rotor core 7 also includes a plurality of first electromagnetic steel plates 20 and a plurality of second electromagnetic steel plates 30, which generally have a disk shape. The rotor core 7 is then constructed of the first electromagnetic steel plates 20 and the second electromagnetic steel plates 30 stacked in the axial direction. In the embodiment, the first electromagnetic steel plates 20 are positioned in an axially central portion, and the second electromagnetic steel plates 30 are positioned on respective axial sides of the first electromagnetic steel plates 20.

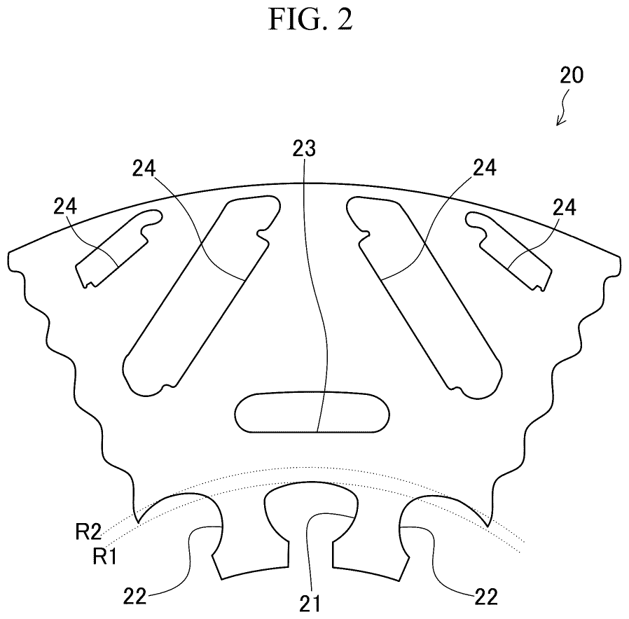

As shown in FIG. 2, the first electromagnetic steel plate 20 includes a plurality of first slits 21 and a plurality of second slits 22, which extend radially outwardly from an inner circumferential surface thereof. The plurality of first slits 21 and the plurality of second slits 22 are arranged at a predetermined distance from each other in the circumferential direction. In the embodiment, the first slits 21 and the second slits 22 are provided in an inner circumferential portion of the first electromagnetic steel plate 20 alternately at 22.5-degree intervals along the circumferential direction.

A plurality of third slits 23 extending circumferentially are provided in locations of the first electromagnetic steel plate 20 radially outward of the plurality of first slits 21 and the plurality of second slits 22. The plurality of third slits 23 are arranged at a predetermined distance from each other in the circumferential direction. In the embodiment, the third slits 23 are provided in a radially middle portion of the first electromagnetic steel plate 20 at 45-degree intervals along the circumferential direction.

A plurality of fourth slits 24 extending in a direction intersecting with the radial direction are provided in locations of the first electromagnetic steel plate 20 radially outward of the plurality of third slits 23.

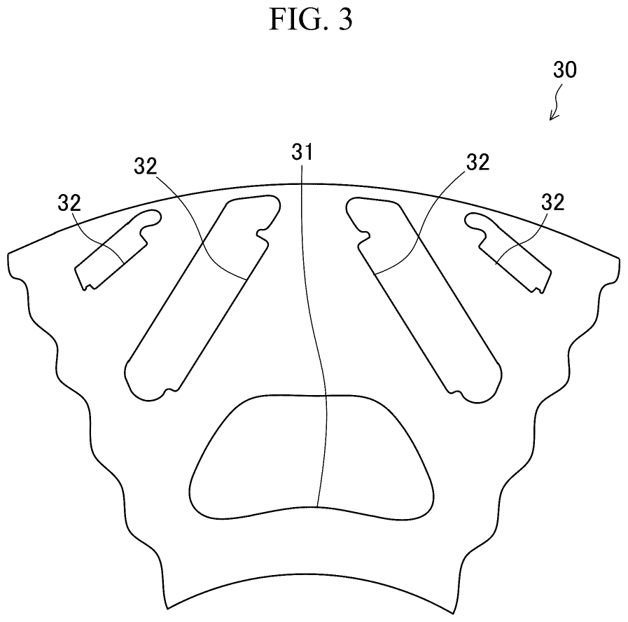

As shown in FIG. 3, the second electromagnetic steel plate 30 includes a plurality of fifth slits 31 which have generally a trapezoidal shape as viewed in the axial direction. The plurality of fifth slits 31 are arranged at a predetermined distance from each other in the circumferential direction. In the embodiment, the fifth slits 31 are provided in inner circumferential portion and radially middle portion of the second electromagnetic steel plate 30 at 45-degree intervals along the circumferential direction.

A plurality of sixth slits 32 extending in a direction intersecting with the radial direction are also provided in locations of the second electromagnetic steel plate 30 radially outward of the plurality of fifth slits 31.

In the embodiment, all of the electromagnetic steel plates (the first electromagnetic steel plates 20 and the second electromagnetic steel plates 30) constructing the rotor core 7 are stacked in the axial direction in the state where circumferential positions of the electromagnetic steel plates are in alignment such that the respective slits (the first slits 21 to the sixth slits 32) in the electromagnetic steel plates (the first electromagnetic steel plates 20 and the second electromagnetic steel plates 30) are in communication in the axial direction, and thereby, an upstream passage 40, a downstream passage 50, a connection passage 60, and a receiving portion 70 are formed (see FIGS. 1, 4, and 5). In explaining in more detail, the first slits 21 and the second slits 22 provided in all of the first electromagnetic steel plates 20 constructing the rotor core 7 are in communication in the axial direction to form the upstream passage 40. The fifth slits 31 provided in all of the second electromagnetic steel plates 30 constructing the rotor core 7 are also in communication in the axial direction to form the downstream passage 50. The third slits 23 provided in all of the first electromagnetic steel plates 20 constructing the rotor core 7 are also in communication in the axial direction to form the connection passage 60. The fourth slits 24 provided in all of the first electromagnetic steel plates 20 constructing the rotor core 7 are also in communication in the axial direction with the sixth slits 32 provided in the second electromagnetic steel plates to form the receiving portion 70.

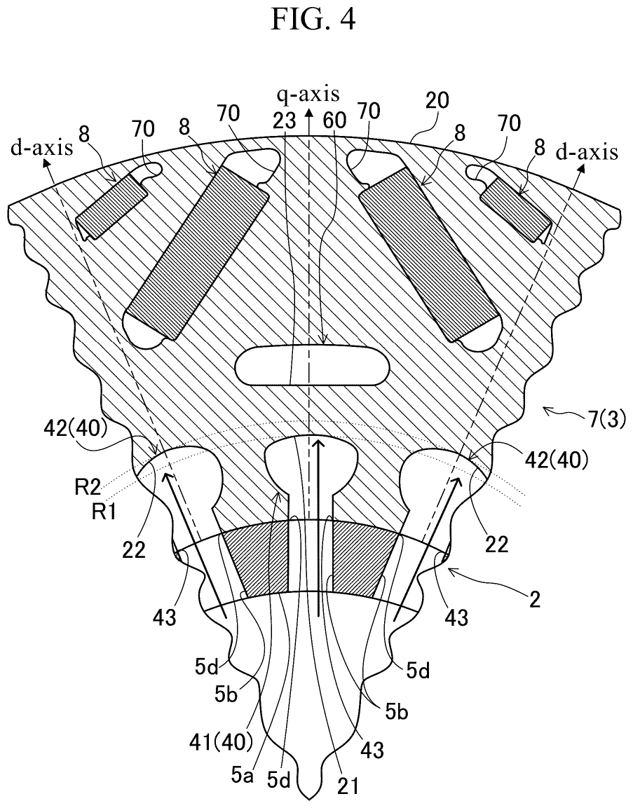

The upstream passage 40 includes a plurality of first upstream passages 41 and a plurality of second upstream passages 42 (see FIG. 4). The first upstream passage 41 includes the first slits 21 provided in the plurality of the first electromagnetic steel plates 20. The second upstream passage 42 includes the second slits 22 provided in the plurality of the first electromagnetic steel plates 20.

The rotor core 7 includes a plurality of second flow inlets 43 that are openings on an inner circumferential surface of the rotor core 7. The second flow inlets 43 are provided at locations facing the first flow outlets 5d of the shaft 2. In the embodiment, the second flow inlets 43 are at 16 locations and provided on the inner circumferential surface of the rotor core 7 at 22.5-degree intervals along the circumferential direction.

The plurality of first upstream passages 41 and the plurality of second upstream passages 42 are provided such that each upstream passage extends radially outwardly from a corresponding second flow inlet 43.

The first upstream passages 41 and the second upstream passages 42 are provided alternately in the circumferential direction. In the embodiment, the first upstream passage 41 extends along a q-axis direction. The second upstream passage 42 extends along a d-axis direction. In the embodiment, the d-axis direction is a central axis direction of magnetic pole of the permanent magnet 8, and the q-axis direction is a central axis direction between magnetic poles of the permanent magnets 8 adjacent to one another in the circumferential direction of the rotor 3.

The plurality of first upstream passages 41 and the plurality of second upstream passages 42 then have generally a mushroom shape in axial cross-section. In other words, the plurality of first upstream passages 41 and the plurality of second upstream passages 42 have outer circumferential portions that have greater circumferential dimensions than inner circumferential portions. In the embodiment, the outer circumferential portions of the plurality of first upstream passages 41 and the plurality of second upstream passages 42 have an elliptical shape in axial cross-section.

In FIG. 4, when viewed in the d-and q-axes directions from the shaft 2, different media exist in circumferential locations corresponding to the d- and q-axes directions. In the circumferential location corresponding to the d-axis direction, there are regions of a gap (the second upstream passage 42) and an electromagnetic steel plate (the first electromagnetic steel plate 20) in that order from a radially inner side toward a radially outer side. On the other hand, in the circumferential location corresponding to the q-axis direction, there are regions of a gap (the first upstream passage 41), an electromagnetic steel plate (the first electromagnetic steel plate 20), a gap (the connection passage 60), and an electromagnetic steel plate (the first electromagnetic steel plate 20) in that order from the radially inner side toward the radially outer side. Thus, the electromagnetic steel plate in the circumferential location corresponding to the q-axis direction makes up a smaller proportion than that of the circumferential location corresponding to the d-axis direction. When the electromagnetic steel plate makes up a smaller proportion, that is, the gap makes up a greater proportion, the mechanical property in the radial direction (for example, mechanical strength against centrifugal force generated during rotation of the rotor 3) is more likely to be low. In FIG. 4, a circumferential distance between the d-axis and its nearest gap (the receiving portion 70) in the rotor 3 is smaller than a circumferential distance between the q-axis and its nearest gap (the receiving portion 70). In this respect, when the circumferential distance from each axis (the d- or q-axis) to its nearest gap (the receiving portion 70) is smaller, the mechanical property in the radial direction is more likely to be low. The embodiment as shown in FIG. 4 demonstrates an example where the circumferential location corresponding to the d-axis direction in the rotor 3 has a lower mechanical property in the radial direction than the circumferential location corresponding to the q-axis direction.

As shown in FIG. 4, a radial distance between the first upstream passage 41 and the connection passage 60 in the circumferential location of the rotor 3 corresponding generally to the q-axis direction is also smaller than a radial distance between the second upstream passage 42 and the receiving portion 70 in the circumferential location corresponding generally to the d-axis direction. Thereby, a portion between the first upstream passage 41 and the connection passage 60 in the radial direction of the rotor 3 has a lower mechanical property in the circumferential direction of the rotor 3 than a portion between the second upstream passage 42 and the receiving portion 70.

When the rotor 3 rotates, the centrifugal force generated by the rotation of the rotor 3 may cause a portion of the circumferential location of the rotor 3 having a relatively lower mechanical property in the radial direction to be susceptible to deformation to expand radially outwardly, as compared to the other portion. In the embodiment, since the circumferential location of the rotor 3 corresponding to the d-axis direction has a lower mechanical property in the radial direction than the circumferential location corresponding to the q-axis direction, a portion of the circumferential location of the rotor 3 corresponding to the d-axis direction deforms to expand radially outwardly, as compared to a portion of the circumferential location of the rotor 3 corresponding to the q-axis direction. As the deformation occurs, stress in the circumferential direction develops in a middle portion (the portion between the first upstream passage 41 and the connection passage 60 and the portion between the second upstream passage 42 and the receiving portion 70) of the rotor 3. In this regard, in the embodiment, a first radial position R1 of an outer circumferential end of the first upstream passage 41 is defined radially inwardly of a second radial position R2 of an outer circumferential end of the second upstream passage 42. In this way, the radial distance between the first upstream passage 41 and the connection passage 60 is greater as compared to the case where the first radial position R1 is defined at the same radial position as the second radial position R2. Thereby, the portion between the first upstream passage 41 and the connection passage 60 has a higher mechanical property in the circumferential direction of the rotor 3 and is thus less susceptible to deformation to expand circumferentially. Thus, the differences in the circumferential mechanical properties of the rotor 3 that vary depending on the circumferential locations of the rotor 3 (for example, differences in the circumferential mechanical properties between the circumferential location of the rotor 3 corresponding generally to the d-axis direction and the circumferential location corresponding generally to the q-axis direction) can be smaller as compared to the conventional ones. As a result, it is possible to reduce portions of the rotor 3 having relatively lower mechanical properties in the circumferential direction. This can reduce the likelihood that the portions having relatively lower mechanical properties in the circumferential direction are subjected to local stress concentration due to the centrifugal force during the rotation of the rotor 3, and thus affect reliability of the rotor 3.

Moreover, the first radial position R1 of the outer circumferential end of the first upstream passage 41 is defined radially inwardly of the second radial position R2 of the outer circumferential end of the second upstream passage 42, so that the outer circumferential end of the first upstream passage 41 is facilitated to have a larger R. This allows distributed stress acting on the outer circumferential portion of the first upstream passage 41 during the rotation of the rotor 3.

In the embodiment, the second radial position R2 of the outer circumferential end of the second upstream passage 42 is defined radially outwardly of the first radial position R1 of the outer circumferential end of the first upstream passage 41. In this way, the radial distance between the second upstream passage 42 and the receiving portion 70 in the circumferential location corresponding generally to the d-axis direction is smaller as compared to the case where the second radial position R2 is defined at the same radial position as the first radial position R1. Thereby, the portion between the second upstream passage 42 and the receiving portion 70 has a lower mechanical property in the circumferential direction of the rotor 3, so that stress acting on the portion between the first upstream passage 41 and the connection passage 60 can be reduced.

As shown in FIG. 1, the downstream passage 50 includes a first downstream passage 51 provided on one axial side of the upstream passage 40, and a second downstream passage 52 provided on another axial side of the upstream passage 40.

The first downstream passage 51 is formed by stacking the second electromagnetic steel plates 30 in the axial direction such that the fifth slits 31 in all of the second electromagnetic steel plates 30 located on the one axial side of the first electromagnetic steel plates 20 are in communication in the axial direction.

The second downstream passage 52 is formed by stacking the second electromagnetic steel plates 30 in the axial direction such that the fifth slits 31 in all of the second electromagnetic steel plates 30 located on the other axial side of the first electromagnetic steel plates 20 are in communication in the axial direction.

The first downstream passage 51 includes an other axial end portion and the second downstream passage 52 includes a one axial end portion, both of which connect to the outer circumferential portion of the upstream passage 40 (the first upstream passage 41 and second upstream passage 42). In other words, the outer circumferential portion of the upstream passage 40 includes a one axial side portion connecting to the first downstream passage 51, and an other axial side portion connecting to the second downstream passage 52.

In the embodiment, the rotor core 7 includes two types of the second electromagnetic steel plates 30 having the fifth slits 31 in different radial positions. The second electromagnetic steel plates 30 having the fifth slits 31 provided on a relatively radially inner side are located on a first electromagnetic steel plates 20 side (axially central side) and the second electromagnetic steel plates 30 having the fifth slits 31 provided on a relatively radially outer side are located on an end plate 9 side (axial end side). Thereby, the first downstream passage 51 and the second downstream passage 52 have a step shape in vertical cross-section. In other words, the first downstream passage 51 and the second downstream passage 52 have respective downstream portions (end plate 9 side portions) located radially outwardly of respective upstream portions (first electromagnetic steel plates 20 side portions).

The other axial end portion of the first downstream passage 51 and the one axial end portion of the second downstream passage 52 are also connected through the connection passage 60 provided radially outwardly of the upstream passage 40. In other words, the connection passage 60 includes a one axial side portion connecting to the first downstream passage 51, and an other axial side portion connecting to the second downstream passage 52. In the embodiment, the first downstream passage 51, the second downstream passage 52, and the connection passage 60 are provided radially inwardly of main paths of magnetic flux (not shown) produced by the rotor 3 and stator 4. This allows reduced interference of main magnetic flux components (not shown) with the first downstream passage 51, the second downstream passage 52, and the connection passage 60, so that the rotary electric machine I can be prevented from having decreased output power associated with arrangement of passages, such as the first downstream passage 51.

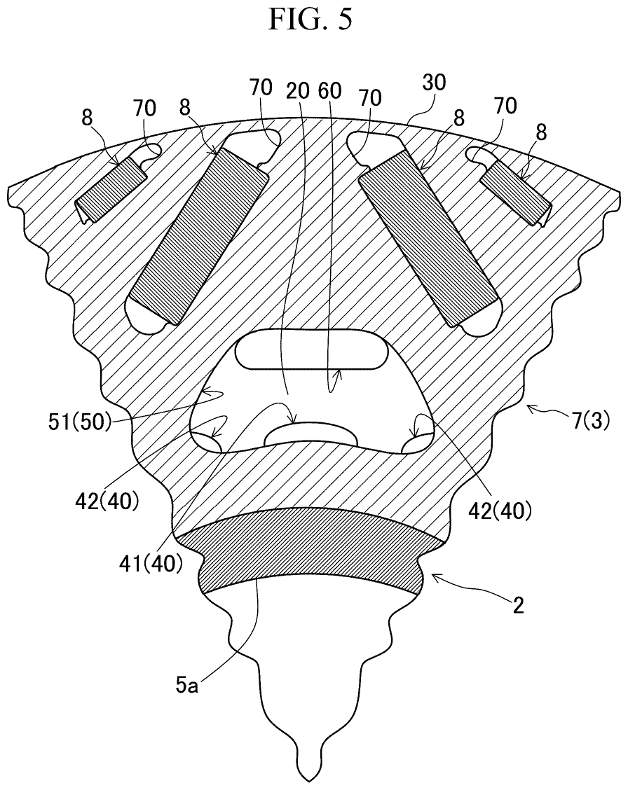

As shown in FIG. 5, in the embodiment, one downstream passage 50 (FIG. 5 showing an example of the first downstream passage 51) connects to one first upstream passage 41 and two second upstream passages 42 that are formed adjacent to the first upstream passage 41 on either circumferential side of the first upstream passage 41. Thereby, the cooling oil from three of the upstream passages 40 flows into the one downstream passage 50.

As shown in FIG. 1, the first downstream passage 51 includes a one axial end portion and the second downstream passage 52 includes an other axial end portion, each of which includes a second flow outlet 7b.

The end plate 9 includes a plurality of flow outlet passages 9a extending radially and arranged at a predetermined distance from each other in the circumferential direction. In the embodiment, the flow outlet passage 9a is configured such that a surface of the end plate 9 facing the rotor core 7 is recessed in a direction axially away from the rotor core 7.

A third flow inlet 9b is provided in a location of an inner circumferential end portion of the flow outlet passage 9a facing the second flow outlet 7b. In other words, the second flow outlet 7b of the downstream passage 50 connects to the third flow inlet 9b of the flow outlet passage 9a.

A third flow outlet 9c is also provided in an outer circumferential end portion of the flow outlet passage 9a. The coil end 4a of the stator 4 is disposed radially outwardly of the third flow outlet 9c at a predetermined radial distance from the third flow outlet 9c. In other words, the third flow outlet 9c is oriented toward the coil end 4a. In the embodiment, the third flow outlets 9c are provided on an outer circumferential surface of the rotor core 7 at 45-degree intervals along the circumferential direction.

The receiving portion 70 is formed such that the fourth slits 24 provided in all of the first electromagnetic steel plates 20 constructing the rotor core 7 are in communication in the axial direction with the sixth slits 32 provided in the second electromagnetic steel plates 30.

The receiving portion 70 is also configured to receive the permanent magnets 8 extending axially. In the embodiment, the permanent magnets 8 received in the receiving portion 70 are arranged in a double-V shape as viewed in the axial direction (see FIGS. 4 and 5).

Next, flow of a cooling oil during rotation (for example, during powering and regenerating) of the rotary electric machine 1 (the shaft 2 and rotor 3) is described with reference to FIG. 1.

A cooling oil retained in an oil reservoir (not shown) is firstly supplied to the first shaft passage 5a of the shaft 2 by means of the oil pump 6. The cooling oil within the first shaft passage 5a then flows into the upstream passage 40 (the first upstream passages 41 and the second upstream passages 42) of the rotor core 7 through the second shaft passages 5b due to centrifugal force generated by rotation of the shaft 2 and the rotor 3 (see FIG. 4).

The cooling oil flowed into the upstream passage 40 next flows radially outwardly within the upstream passage 40 to the outer circumferential portion of the upstream passage 40 due to the centrifugal force generated by the rotation of the shaft 2 and the rotor 3. The cooling oil reached the outer circumferential portion of the upstream passage 40 then flows into the downstream passage 50 connected to the outer circumferential portion of the upstream passage 40.

In the embodiment, the cooling oil within the upstream passage 40 flows into the first downstream passage 51 provided on the one axial side of the upstream passage 40, and the second downstream passage 52 provided on the other axial side of the upstream passage 40. In this respect, the first downstream passage 51 and the second downstream passage 52 are connected through the connection passage 60. Thereby, the cooling oil within the first downstream passage 51 can flow into the second downstream passage 52 through the connection passage 60, and the cooling oil within the second downstream passage 52 can flow into the first downstream passage 51 through the connection passage 60. Thus, the connection passage 60 allows amounts of the cooling oil flowing in the first downstream passage 51 and the second downstream passage 52 to be brought in balance.

The cooling oil flowed into the downstream passage 50 flows within the downstream passage 50 along the axial direction and then into the flow outlet passages 9a. In this regard, the downstream passage 50 is provided radially inwardly of the receiving portion 70 to extend in the axial direction along the receiving portion 70. Thereby, the cooling oil flowing within the downstream passage 50 cools a radially inner portion of the receiving portion 70 in the rotor core 7. When the radially inner portion is cooled, the permanent magnets 8 received in the receiving portion 70 are cooled from the radially inner side. This can reduce the likelihood that the permanent magnets 8 have a temperature increase to the temperature that may cause irreversible demagnetization, for example.

The cooling oil flowed into the flow outlet passages 9a flows radially outwardly within the flow outlet passages 9a and then flows out radially outwardly from the third flow outlets 9c, due to the centrifugal force generated by the rotation of the shaft 2 and the rotor 3. In this respect, the third flow outlets 9c are oriented toward the coil end 4a, so that the cooling oil flowing out from the third flow outlets 9c is applied (supplied) onto the coil end 4a. Thereby, the cooling oil used for cooling the permanent magnets 8 also can be utilized for cooling the coil end 4a. The third flow outlets 9c are also provided at predetermined intervals along the circumferential direction (provided at a total of eight locations at 45-degree intervals in the embodiment), so that the cooling oil flowing out from the third flow outlets 9c can be applied onto the entire coil end 4a. Thereby, this can reduce different application of the cooling oil depending on circumferential locations of the coil end 4a, i.e., distributed temperatures in the circumferential direction.

As described above, in the embodiment, the cooling oil flowing from shaft passage 5 into the rotor passage (the upstream passage 40 and the downstream passage 50) can cool the permanent magnets 8. The first radial position R1 of the outer circumferential end of the first upstream passage 41 is also different from the second radial position R2 of the outer circumferential end of the second upstream passage 42, so that the differences in the mechanical properties of the rotor 3 that vary depending on the circumferential locations can be smaller as compared to the conventional ones. Thereby, even when local stress concentration develops due to the centrifugal force during the rotation of the rotor 3, it is possible to reduce its influence on reliability of the rotor 3.

The first radial position R1 of the outer circumferential end of the first upstream passage 41 that extends along the q-axis direction is also different from the second radial position R2 of the outer circumferential end of the second upstream passage 42 that extends along the d-axis direction, so that the differences in the mechanical properties of the rotor 3 between the circumferential locations corresponding to the q-axis and d-axis directions can be smaller as compared to the conventional ones.

The first upstream passages 41 and the second upstream passages 42 are also provided alternately in the circumferential direction of the rotor 3. Thereby, the differences in the mechanical properties of the rotor 3 that vary depending on the circumferential locations can be further smaller as compared to the conventional ones.

The outer circumferential portion of the upstream passage 40 has an elliptical shape in axial cross-section. Thereby, the outer circumferential portion of the upstream passage 40 has a larger R as compared to the case of a round shape. This allows distributed stress acting on the outer circumferential portion of the upstream passage 40 during the rotation of the rotor 3, for example.

The second flow inlets 43 are also provided in the axially central portion of the rotor 3, so that the cooling oil flowing from the shaft passage 5 into the upstream passage 40 can be used to preferentially cool axially central portions of the permanent magnets 8, where the temperature is most likely to be higher, over other portions of the permanent magnets 8. Thereby, the axially central portions of the permanent magnets 8 can be prevented from having a higher temperature. The radial position of the outer circumferential end of the first upstream passage 41 provided radially inwardly of the connection passage 60 is also defined radially inwardly of the radial position of the outer circumferential end of the second upstream passage 42. Thereby, the proportion of the first upstream passage 41 (gap) in the circumferential location where the connection passage 60 is provided can be relatively reduced, so that the differences in the mechanical properties of the rotor 3 between the circumferential location including the first upstream passage 41 and the connection passage 60 and the circumferential location including the second upstream passage 42 can be smaller.

The cooling oil used for cooling the permanent magnets 8 as passing through the downstream passage 50 flows out from the third flow outlets 9c to be supplied to the coil end 4a. Thereby, the cooling oil after cooling the permanent magnets 8 also can be used for cooling the coil end 4a.

The rotor 3 and the shaft 2 are fixed using shrink-fitting, so that fixing of the rotor 3 to the shaft 2 can be ensured. The upstream passage 40 extending radially outwardly from the second flow inlets 43 that are openings on the inner circumferential surface of the rotor 3 also can reduce shrink-fitting stress acting on the rotor 3. This can further improve the reliability of the rotor 3.

The first downstream passage 51 and the second downstream passage 52 also include respective upstream portions that are located radially inwardly of respective downstream portions, so that the outer circumferential end of the upstream passage that connects to the first downstream passage 51 and the second downstream passage 52 can be located radially inwardly. Thereby, this reduce a lowered mechanical property of the rotor 3 caused by radially elongated upstream passage 40. Further, the first downstream passage 51 and the second downstream passage 52 include the respective downstream portions that are located radially outwardly of the respective upstream portions, so that the downstream portions are radially closer to the permanent magnets 8 to increase performance of cooling the permanent magnets 8 by the cooling oil flowing in the first downstream passage 51 and the second downstream passage 52.

The first downstream passage 51 and the second downstream passage 52 are connected through the connection passage 60, so that the difference between the amounts of the cooling oil flowing in the first downstream passage 51 and the second downstream passage 52 can be smaller.

In the embodiment, the rotary electric machine 1 is described using the example of an electric motor; however, it may be used for an electrical generator. The rotary electric machine 1 may also be used for those other than the drive source of an electric vehicle.

In the embodiment, the rotary electric machine 1 is described using the example of an internal magnet type; however, it may be of a surface magnet type.

In the embodiment, the rotor core 7 is constructed of the stacked plurality of electromagnetic steel plates; however, it may be constructed of a single component, such as a casting.

In the embodiment, the permanent magnets 8 are arranged in a V shape as viewed in the axial direction; however, they may be arranged in a shape other than the V shape (for example, ∇ shape).

The embodiment describes the example where the radial position of the outer circumferential end of the second upstream passage 42 is defined radially outwardly of the radial position of the outer circumferential end of the first upstream passage 41; however, the radial position of the outer circumferential end of the second upstream passage 42 may be defined radially inwardly of the radial position of the outer circumferential end of the first upstream passage 41. In this way, for example, the differences in the radial mechanical properties of the rotor 3 that vary depending on the circumferential locations can be smaller as compared to the conventional ones. In explaining in more detail, when the outer circumferential end of the upstream passage 40 is located more radially outwardly, the upstream passage 40 makes up a greater proportion in the circumferential location of the rotor core 7, resulting in a relatively lower mechanical property of the circumferential location in the radial direction. In contrast, when the outer circumferential end of the upstream passage 40 is located more radially inwardly, the upstream passage 40 makes up a smaller proportion in the circumferential location of the rotor core 7, resulting in a relatively higher mechanical property of the circumferential location in the radial direction. Thus, in the circumferential location of the rotor core 7 having a relatively lower radial mechanical property, the radial position of the outer circumferential end of the second upstream passage 42 is defined at a relatively inner circumferential side (radially inward) to decrease the proportion of the second upstream passage 42 (gap), i.e., to increase the proportion of the electromagnetic steel plate, thereby enabling a higher radial mechanical property of the circumferential location. In contrast, in the circumferential location of the rotor core 7 having a relatively higher radial mechanical property, the radial position of the outer circumferential end of the first upstream passage 41 is defined at a relatively outer circumferential side (radially outward) to increase the proportion of the first upstream passage 41 (gap), i.e., to decrease the proportion of the electromagnetic steel plate, thereby enabling a lower radial mechanical property of the circumferential location. Therefore, the radial positions of the outer circumferential ends of the first upstream passage 41 and the second upstream passage 42 are adjusted so that the variations in the radial mechanical properties between the circumferential locations of the rotor core 7 can be reduced.

In the embodiment, the first upstream passages 41 extend along the q-axis direction and the second upstream passages 42 extend along the d-axis direction; however, the first upstream passages 41 may extend along the d-axis direction and the second upstream passages 42 may extend along the q-axis direction.

In the embodiment, for example, the differences in the circumferential mechanical properties depending on the circumferential locations of the rotor 3 are taken into account to define the radial position of the outer circumferential end of the first upstream passage 41 radially inwardly of the radial position of the outer circumferential end of the second upstream passage 42; however, various factors that cause differences in at least one of the radial and circumferential mechanical properties depending on the circumferential locations of the rotor 3 may be taken into account to define the radial positions of the outer circumferential ends of the upstream passages 40 such that the differences in at least one of the radial and circumferential mechanical properties depending on the circumferential locations are a smaller. The factors include, but not limited to, the presence and absence, sizes, materials, and shapes of regions of the gaps, the electromagnetic steel plate, and the permanent magnets 8 in the rotor 3, as well as a radial distance between each axis (d- or q-axis) and a gap, circumferential distances between multiple adjacent gaps, and radial distances between multiple adjacent gaps.

In the embodiment, the first upstream passages 41 and the second upstream passages 42 are provided alternately in the circumferential direction of the rotor 3; however, they may not be alternately provided and, for example, the first upstream passages 41 may be provided to align successively in the circumferential direction.

In the embodiment, the outer circumferential portion of the upstream passage 40 (the first upstream passage 41 and the second upstream passage 42) has an elliptical shape in axial cross-section, but it may have a shape in axial cross-section other than the elliptical shape (for example, a round shape).

In the embodiment, the second flow inlets 43 are provided in the axially central portion of the rotor 3, but may be provided in a portion other than the central portion.

In the embodiment, the first downstream passage 51 and the second downstream passage 52 are provided; however, one of the first downstream passage 51 and the second downstream passage 52 may only be provided.

In the embodiment, the first downstream passage 51 and the second downstream passage 52 have a step shape in radial cross-section such that the respective downstream portions are located radially outwardly of the respective upstream portions; however, the first downstream passage 51 and the second downstream passage 52 may be located progressively radially outwardly toward a downstream side, or located progressively radially inwardly toward the downstream side, or located at same radial position toward the downstream side.

In the embodiment, the connection passage 60 connecting the first downstream passage 41 and the second downstream passage 42 is provided, but the connection passage 60 may not be provided.

In the embodiment, a cooling oil flowing out from the flow outlet passages 9a is applied onto the coil end 4a; however, the flow outlet passages 9a are configured such that a cooling oil is applied to a cooling-or lubrication-requiring portion other than the coil end 4a.

In the embodiment, the flow outlet passages 9a are provided, but the flow outlet passages 9a may not be provided. In that case, for example, a cooling oil within the first and second downstream passages 51, 52 may flow out in the axial direction via a hole (not shown) formed to extend through the respective end plates 9 in a thickness direction (axial direction) of the end plate 9.

In the embodiment, the shaft 2 and the rotor 3 are fixed by means of shrink-fitting; however, if relative rotation of the shaft 2 and the rotor 3 can be restricted, the shaft 2 and the rotor 3 may be fixed by using a means other than shrink-fitting, or the shaft 2 and the rotor 3 may be formed as one piece.

The embodiment also describes the example where a cooling oil is used as the liquid coolant; however, a liquid coolant other than the cooling oil (for example, cooling water) may be used.

Although the present disclosure is described with reference to examples, it is understood that the present disclosure is not limited to such examples or structures. The present disclosure also encompasses various variants, and modifications falling within equivalents thereof. In addition, various combinations and configurations, as well as other combinations and configurations including more, less or only a single element therein, also fall within the scope and spirit of the present disclosure.

The present disclosure is suitable for a rotary electric machine that can be used for a drive source of an electric vehicle, for example.

What is claimed is:

1. A rotary electric machine comprising:
a rotor including a permanent magnet;
a shaft configured to rotatably support the rotor;
a shaft passage provided inside the shaft; and
a rotor passage into which a liquid coolant flows from the shaft passage through a flow inlet that is an opening on an inner circumferential surface of the rotor,
wherein the rotor passage includes an upstream passage extending radially outwardly from the flow inlet, and a downstream passage connecting to the upstream passage and extending in an axial direction,
the upstream passage includes a first upstream passage and a second upstream passage arranged in a circumferential direction of the rotor, and
a radial position of an outer circumferential end of the first upstream passage is defined radially outwardly or radially inwardly of a radial position of an outer circumferential end of the second upstream passage.

2. The rotary electric machine according to claim 1, wherein the first upstream passage extends along a q-axis direction, and
the second upstream passage extends along a d-axis direction.

3. The rotary electric machine according to claim 1, wherein the first upstream passage and the second upstream passage are provided alternately in the circumferential direction of the rotor.

4. The rotary electric machine according to claim 1, wherein an outer circumferential portion of the upstream passage has an elliptical shape in axial cross-section.

5. The rotary electric machine according to claim 1, wherein the flow inlet is provided in an axially central portion of the rotor,
the downstream passage includes a first downstream passage provided on one axial side of the upstream passage, and a second downstream passage provided on another axial side of the upstream passage,
the radial position of the outer circumferential end of the first upstream passage is defined radially inwardly of the radial position of the outer circumferential end of the second upstream passage, and
a connection passage provided radially outwardly of the first upstream passage extends in the axial direction and connects the first downstream passage and the second downstream passage.

6. The rotary electric machine according to claim 1, further comprising:
a stator provided radially outside the rotor,
a coil end provided in an axial end portion of the stator,
an end plate provided in an axial end portion of the rotor, and
a flow outlet passage provided in the end plate and extending in a radial direction,
wherein the flow outlet passage includes an inner circumferential portion connecting to the downstream passage, and an outer circumferential end including a flow outlet oriented toward the coil end.

7. The rotary electric machine according to claim 1, wherein the rotor and the shaft are fixed by means of shrink-fitting.
